(19) United States
(12) Patent Application Publication
(10) Pub. No.: US 2011/0133955 A1
(43) Pub. Date: Jun. 9, 2011

(54) Traffic control system using multiple yellow lights to divide a cautionary signal into equal parts

(76) Inventors: Carey Plazak, Palatine, IL (US); Joseph Plazak, Palatine, IL (US)

(21) Appl. No.: 12/592,843

(22) Filed: Dec. 4, 2009

(51) Int. Cl. G08G 1/096

(52) U.S. Cl. 340/929

(57) ABSTRACT

A traffic control system for controlling vehicular traffic flow at intersections in which the conventional red/yellow/green three-light traffic signal that informs a motorist to stop, prepare to stop, and go is supplemented with multiple yellow light signals which are integrated as part of the traffic light. The additional yellow light signals inform a motorist that they will have sufficient time to make a gradual normal stop at the intersection before the red stop light is switched on by dividing the duration of the yellow cautionary signal into multiple yellow light signals.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to vehicular traffic control systems, and more particularly to a traffic control system employing a traffic control signal device comprising, for each direction of traffic flow, a red “STOP” signal, a green “GO” signal, and a yellow “CAUTION” signal that indicates the red “STOP” signal is about to be actuated.

2. Prior Art

This new traffic control signal device, herein after referred to as “signal device,” recognizes a distinction among the STOP, GO, and CAUTION signals, and the information displayed to drivers of vehicles. The current conventional signal system employs the red light signal to indicate that vehicle motion is to be stopped, the green light signal to indicate that vehicle motion is permitted, and a yellow light signal to represent an interval of time between the red and green signals. This type of signal system, which indicates either a state of motion, a state of non-motion, or a period of time, is somewhat illogical and distorted. Not only are two properties being represented within the same signal device, the signal device employs the same method to represent the two distinct properties; that is, a colored light represents both motion and time.

This new signal device addresses the problem of mixed messages delivered to drivers of vehicles from conventional signals by employing a CAUTION signal that equally divides and quantifies the time interval established for the CAUTION signal. This new signal device employs multiple yellow light signals which collectively present a quantifiable warning that the STOP signal is soon to be actuated. The use of a multi-part yellow light CAUTION signal, which equally divides the time duration of the CAUTION signal, will provide drivers of vehicles with additional information to determine the precise time interval before the STOP signal is actuated as opposed to merely signaling that the STOP signal will soon be activated.

### PRIOR ART

The use of traffic light sequence indicators is known in the prior art. Further, the prior art consists of many designs which have been developed for the fulfillment of numerous objectives and requirements.

Known prior art includes U.S. Pat. Nos. RE40,737; 7,538,689; 4,200,860; 7,468,680; 7,443,315; 7,330,130; 7,187,301; 6,833,796; 6,552,668; 6,331,824; 6,380,867; 6,310,562; 6,268,805; 6,087,962; 5,838,260; 5,726,648; 4,908,616; and 4,827,258.

While these devices fulfill their respective, particular objectives and requirements, the aforementioned patents do not disclose a quantifiable multi-part yellow CAUTION signal which divides the length of the yellow signal into equal parts. The proposed signal device modifies only the yellow signal and allows drivers of vehicles to quantify the amount of time before the signal changes from yellow to red via a simple, intuitive sequence of multiple yellow lights. Sequenced lights are easily interpreted and can be seen from a distance, unlike numeric displays (U.S. Pat. Nos. RE40,737; 6,833,796; 6,380,867; 6,268,805) and non-standard or diminishing-intensity lights (U.S. Pat. Nos. 7,443,315; 7,330,130; 6,552,668; 6,310,562; 5,838,260) Further, the duration of the sequence can be easily altered as necessary to provide precise information to drivers of vehicles at an intersection of any size. The proposed signal device described here incorporates additional information into the existing standard traffic signal device so as to provide drivers of vehicles with the ability to quantify the duration of a yellow light without displacing their attention elsewhere, such as roadway markings (U.S. Pat. No. 7,468,680) or auxiliary signals placed along the roadway (U.S. Pat. No. 7,187,301). The use of sequenced multiple yellow warning signals, as opposed to a single blinking signal (U.S. Pat. No. 4,827,258), allow drivers of vehicles to determine precisely when the signal will change, not merely that the signal is about to change. This information is crucial to motorists because yellow CAUTION signals vary in length for a variety of reasons.

In these respects, this traffic control system employing multiple yellow lights to divide a cautionary signal into equal parts, substantially departs from the conventional concepts and designs of the prior art, and in so doing provides an signal primarily developed for the purpose of indicating the remaining duration of a yellow CAUTION signal light.

### SUMMARY

This new signal device employs a red light signal to indicate vehicular traffic motion is to stop, a green light signal to indicate vehicular traffic motion is to proceed, and a multiple yellow light signal to indicate a warning that the red signal light is soon to be actuated. The multi-part yellow light CAUTION signal divides the time interval of what is currently represented by a single yellow light CAUTION signal employed in conventional traffic control signal systems.

For example (example #1), if the time interval of the CAUTION signal is set for three seconds and the new signal device employs a CAUTION signal with three yellow lights, each light would represent one second of the CAUTION signal. The new signal device would change from a green GO light signal to the multi-part yellow CAUTION light signal and then to a red STOP light signal. When the signal device changes from a GO signal to the multi-part yellow CAUTION light signal, all three yellow lights would be activated. As each second of the CAUTION signal lapses, one of the yellow lights signals would be extinguished. As the final moment of the CAUTION signal lapses, all yellow light signals would be extinguished and the STOP signal would be immediately illuminated.

As a second example (example #2), if the time interval of the CAUTION signal is set for four and a half seconds and the new signal device employs a CAUTION signal with three yellow lights, each light would represent one and a half seconds of the CAUTION signal. The same activation and deactivation of the CAUTION signal as described in example #1 would take place, except in this example, each yellow light signal would represent one and a half seconds of the cautionary light sequence.

If the latter example (example #2) were considered again, yet this time with a traffic signal device employing a CAUTION signal with four yellow lights, the time interval for each yellow light in the CAUTION signal sequence would be 1.125 seconds. The variations and combinations of yellow CAUTION signal lights and time intervals can be varied as necessary and customized for each traffic signal device.

In summary, the new signal device can provide more accurate information to drivers of vehicles by addressing that the CAUTION signal represents a period of time; a much different property than a state of motion or non-motion as represented by the green GO and red STOP signals. The new device accomplishes this via a sequenced multi-part yellow CAUTION signal light that divides the time interval of the CAUTION signal into equal parts represented by the number of illuminated lights. The variations and combinations of yellow CAUTION signal lights and time intervals can be as many as necessary and need not be limited.

### DRAWINGS

### Figures

The design and operation of the new signal device is submitted in a single drawing with seven figures.

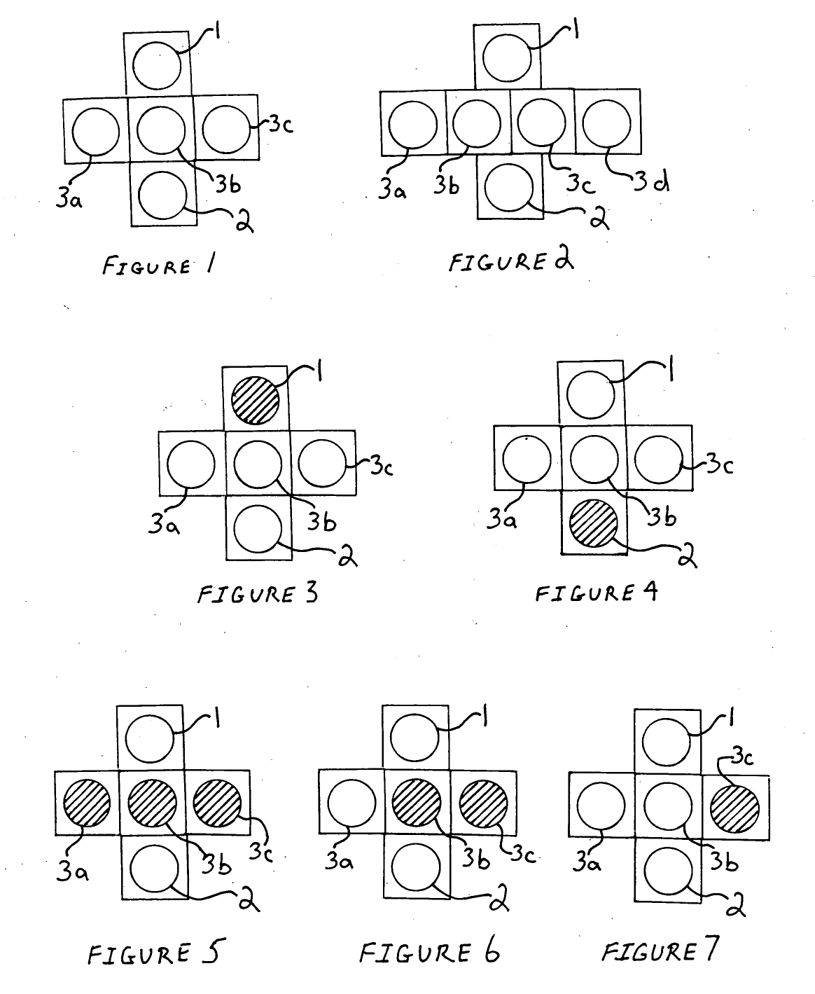

FIG. 1 indicates the basic layout of signal lights in the new device.

FIG. 2 indicates one of many variations of light layouts that can be used to incorporate the new multi-part CAUTION signal.

FIGS. 3 through 7 illustrate how the STOP, GO, and CAUTION light signals will sequence through a cycled operation.

### REFERENCE NUMERALS

The reference numerals used in the drawings are consistent throughout FIGS. 1 through 7.
Circles marked 1 represent red STOP signal lights.
Circles marked 2 represent green GO signal lights.
Circles marked 3 represent yellow CAUTION signal lights.
Circles marked with a lowercase letter after the numeric marking represent lights that are operated in a coordinated sequence within the same signal.

### DETAILED DESCRIPTION

A description of the signal device is herein given. FIGS. 1 and 2 represent typical light layout patterns that incorporate a sequenced yellow cautionary light system.

Starting with FIG. 3, the operating sequence of the signal device is represented. A shaded circle represents a light that is illuminated and an un-shaded circle represents a light that is not illuminated. FIG. 3 indicates that the circle marked 1, the red STOP light signal, is illuminated. This STOP signal may be illuminated for any duration of time as required by those responsible for the traffic at the intersection. FIG. 4 indicates that the circle marked 2, the green GO light, is illuminated. This GO signal may be illuminated for any duration of time as required by those responsible for the traffic at the intersection. FIG. 5 indicates that all the circles marked 3, the yellow CAUTION signal lights, are illuminated. This sequence of yellow CAUTION signal lights may be illuminated for any duration of time required by those responsible for the traffic at the intersection.

This new signal device replaces the familiar single yellow CAUTION signal light with a series of sequenced lights represented in the drawings by the number 3 and any accompanying lowercase letters. These sequenced lights equally divide the duration of the CAUTION signal. The time duration may be of any length as required by those responsible for the traffic at the intersection.

The operation of this sequencing is represented in FIGS. 5 through 7 using a three yellow CAUTION light configuration for illustrative purposes. In this configuration the CAUTION signal is divided equally into three parts. FIG. 5 represents all yellow lights illuminated, marked 3a, 3b, and 3c, and the beginning of the sequence which indicates to drivers of vehicles that at least more than two thirds of the CAUTION signal remains. FIG. 6 indicates only two yellow lights illuminated, marked 3b and 3c; representing that at least more than one third of the time for the CAUTION signal remains. FIG. 7 indicates only one yellow light is illuminated, marked 3c indicating that less than one third of the CAUTION signal time remains. When the final one third of the time duration for the CAUTION signal expires, the device will change to the state represented in FIG. 3 and the STOP signal will be illuminated. In addition to providing fractional information to drivers of vehicles, the sequential deactivation of lights, due to their equivocal nature, allows drivers of vehicles to determine the precise time at which the CAUTION signal will change to a STOP signal. The entire sequence of the signal device will cycle and repeat.

### CONCLUSION

In conclusion, the signal device is effective at controlling traffic and indicating CAUTION signal time information for drivers of vehicles. The simple design makes this new signal device intuitive and easy to follow. Minimal experience with the new signal device should be sufficient to educate drivers that rely on the traffic control signals for safety at intersections. The multi-part CAUTION signal is easily visible unlike other prior art that segments lights into small parts or employs hard to read numerical count-down timers. The position of the multi-part CAUTION signal light is in a familiar position situated below the red STOP light signal and above the green GO light signal. This is the position expected by drivers of vehicles which adds to the ease of understanding, unlike other prior art that places warning lights above or beside the traffic control devices. The same qualities that make this layout design easy to understand also allow for easy manufacturing. This multi-part sequenced yellow CAUTION light signal could be an integral part of a completely new signal device, or it could be manufactured as a retro-fit to a conventional traffic control signal. The multi-part CAUTION light signal can be controlled within the existing signal device, thus eliminating the need for an expensive auxiliary unit to be installed at each intersection. Further, there are no added devices that need to be placed before the intersection along the roadway, thus eliminating costs and jurisdictional issues between agencies responsible for roadway maintenance and agencies responsible for traffic control and signal maintenance.

We claim:

1. A system for controlling vehicular traffic flow at a roadway intersection comprising a traffic signal device located at the intersection having a red stop light which when operated indicates that traffic is to stop at the intersection, a green go light which when operated indicates that traffic is to go through the intersection, and a multi-part yellow cautionary light which when operated indicates that the red light is soon to be activated; cautionary light means comprising of multiple yellow lights dividing the duration of the cautionary signal into equal parts; whereby the cautionary signal means being such that a motorist will be able to determine the duration of the cautionary signal in order to determine whether to proceed through or prepare to stop at the intersection.

2. A traffic control system according to claim 1 wherein said cautionary means comprises multiple yellow lights which are collectively activated and then individually and sequentially deactivated in a timeframe that divides the cautionary signal into equal parts.

3. A traffic control system according to claim 1 wherein said cautionary means comprises multiple yellow lights which are individually and sequentially activated until all cautionary lights are illuminated in such a manner as to divide the cautionary signal into equal parts.
